(19) United States
(12) Patent Application Publication
(10) Pub. No.: US 2024/0347879 A1
(43) Pub. Date: Oct. 17, 2024

(54) BATTERY CELL INCLUDING AN ELECTRODE CONDUCTOR INSULATION

(71) Applicant: Volkswagen Aktiengesellschaft, Wolfsburg (DE)

(72) Inventors: Lukas KWOCZEK, Braunschweig (DE); Frederik GRAU, Braunschweig (DE)

(73) Assignee: Volkswagen Aktiengesellschaft, Wolfsburg (DE)

(21) Appl. No.: 18/635,506

(22) Filed: Apr. 15, 2024

(30) Foreign Application Priority Data
Apr. 14, 2023 (DE) 10 2023 203 411.5

(51) Int. Cl. H01M 50/54; H01M 10/04; H01M 50/103; H01M 50/15; H01M 50/474; H01M 50/477; H01M 50/486

(52) U.S. Cl. CPC H01M 50/54; H01M 10/049; H01M 50/103; H01M 50/15; H01M 50/474; H01M 50/477; H01M 50/486

(57) ABSTRACT

A battery cell having a layer stack including anode layers and corresponding cathode layers. The anode and cathode layers being stacked alternately one on top of the other. A separator layer is arranged between each anode and cathode layer. Anode or cathode conductor tracks are guided laterally out of the layer stack at least from some of the anode layers and/or some of the cathode layers at least on a first end face of the layer stack. The anode conductor tracks or the cathode conductor tracks being combined in a bundled manner and each contacted on the anode current collector or on the cathode current collector. The bundles of the anode or cathode conductor tracks are each passed between two folds, and insulation layers are held in position by a spring action of their particular folds against a pressure being applied indirectly by the first cover.

This nonprovisional application claims priority under 35 U.S.C. § 119 (a) to German Patent Application No. 10 2023 203 411.5, which was filed in Germany on Apr. 14, 2023, and which is herein incorporated by reference.

### BACKGROUND OF THE INVENTION

### Field of the Invention

The invention relates to a battery cell, comprising a layer stack, which includes a plurality of anode layers stacked alternately one on top of the other and a corresponding plurality of cathode layers, as well as separator layers arranged therebetween in each case, and a housing which surrounds the layer stack with anode or cathode conductor tracks guided out of the side of the layer stack, and which includes a cover with inner anode or cathode current collectors on an end face of the layer stack.

### Description of the Background Art

Battery cells today are usually available in three different designs: Prismatic cells have a rigid frame or a rigid housing, within which the individual anode, cathode, and separator layers are arranged. The layers are each connected to corresponding anode or cathode terminals enclosed within the housing via conductor tracks, which are guided out of the stack of layers. In cylindrical cells, stacks of anode and cathode layers are wound into each other, the electrical contacting for the anode or cathode layers taking place along the cylinder axis or on the outside of the cylinder. In so-called pouch cells, the anode and cathode layers are stacked one on top of the other over a wide area and are surrounded by a flexible foil for protection against the surroundings, from which only two printed conductors of the anodes or cathodes project.

In prismatic battery cells, the rigid housing not only offers mechanical stability for the cell, but also facilitates the use of stable electrical connections and also permits a good thermal connection to the surroundings and thus a comparatively good dissipation of resulting heat, which has a positive effect on the lifespan of the cells.

However, the conductor tracks, which are guided out of the layer stack in bundles in each case to an anode or cathode current collector, where they are contacted, must be electrically insulated against the housing. If necessary, these bundles also form a kind of loop between the layer stack and the current collectors within the housing, at which an insulation must preferably also take place.

The application of an insulation of this type is difficult to effectuate in production, since the conductor tracks are often formed from the uncoated copper or aluminum substrate foils of the relevant electrode layers and therefore have a thickness of, in some cases, only 4 μm to 15 μm. These conductor tracks may therefore easily crumple or tear. However, a guiding of the conductor tracks also takes the approach that a separate insulation may be dispensed with. The fixing of insulations, however, is not trivial in this context.

### SUMMARY OF THE INVENTION

It is therefore an object of the invention to provide a battery cell, in which the conductor tracks of the individual electrode layers are insulated against a housing in a manner which is particularly easy to achieve. The object of the invention is furthermore to provide a method for manufacturing a battery cell of this type.

In an example, the object is achieved according to the invention by a battery cell, in particular a prismatic battery cell, which comprises a layer stack, which includes a plurality of anode layers and a corresponding plurality of cathode layers, the anode layers and the cathode layers being stacked alternately one on top of the other, and a separator layer being arranged between each anode layer and each cathode layer, and anode or cathode conductor tracks being guided laterally out of the layer stack at least from some of the anode layers and/or some of the cathode layers at least on a first end face of the layer stack. The battery cell further comprises a housing, which surrounds the layer stack including the anode or cathode conductor tracks and which has a first cover with an inner anode current collector or an inner cathode current collector at least on the first end face of the layer stack, the anode conductor tracks or the cathode conductor tracks each being combined in a bundled manner, and each being contacted on the anode current collector or on the cathode current collector. The battery cell also comprises at least two insulation layers, which are each fastened by a first end to an upper side or a lower side of the layer stack, the insulation layers each projecting over the layer stack by their free second ends, and these second ends being oriented with respect to each other, forming folds running toward each other, so that the bundles of anode conductor tracks or cathode conductor tracks are each passed between the two folds, the insulation layers being held in position by a spring effect of their particular folds against a pressure which is applied indirectly by the first cover.

The second-mentioned object is achieved according to an example of the invention by a method for manufacturing a battery cell, a plurality of anode layers and a plurality of cathode layers being stacked alternately into a layer stack, and a separator layer being arranged between each anode layer and each cathode layer, and anode conductor tracks or cathode conductor tracks being guided laterally out of the layer stack at least from some of the anode layers and from some of the cathode layers and combined in a bundled manner, and being contacted with an anode current collector or a cathode current collector of a cover or a particular cover for a housing of the battery cell.

According to the method, it is provided that at least one insulation layer can be fastened in each case on an upper side or a lower side of the layer stack in such a way that the layer stack projects over the insulation layer, the free ends of these insulation layers are each guided from above or from below in the direction of the bundles of anode conductor tracks or cathode conductor tracks, forming a fold, the cover or the particular cover is pressed in the direction of the layer stack, so that a pressure is applied to the free ends of these insulation layers outside the particular fold, and the layer stack is fastened by the pressed-on cover and enclosed thereby or thereafter within the housing.

The method according to the invention for manufacturing a battery cell shares the advantages of the battery cell according to the invention. The advantages specified for the battery cell and its refinements may be likewise transferred mutatis mutandis to the method and vice versa.

The battery cell can preferably be constituted by a lithium (Li)-ion battery cell. The anode and cathode layers (also referred to below collectively as electrode layers) are preferably constituted by a coating of a particular, in particular foil-like, substrate having an active material. A copper substrate foil is preferably taken for the anode layers, a coating made up of graphite or silicon (Si) or a silicon oxide (SiOx) being preferably applied as the active material. An aluminum substrate foil is preferably used to manufacture cathode layers K, a coating made up of lithium ferrophosphate (LFP) or of one or multiple lithium nickel manganese cobalt oxides (Li-NMC) being applied as the active material. The separator layers may each be constituted, in particular, by a ceramic-coated plastic film.

An alternating arrangement of the anode layers and cathode layers in the layer stack (including the separator layers arranged therebetween in each case) can be understood to be, in particular, that the layer stack is constructed from a plurality (preferably a multiplicity) of elementary cells, which each include an anode layer, a separator layer, and a cathode layer. In particular, the substrate foils for the anode and cathode layers may also be coated on both sides with the associated active material, so that, in this case, the alternating sequences of anode layers and cathode layers are mirrored on the particular substrate foils (i.e., for example, the aluminum substrate foil of the cathode layer first follows a sequences of anode layer-separator layer-cathode layer as the elementary cell, and an elementary cell subsequently follows the sequence of cathode layer-separator layer-anode layer, with a correspondingly connecting copper substrate foil, and a periodic repetition of the aforementioned sequence forms the layer stack).

Anode conductor tracks are guided out of some of the anode layers of the layer stack, preferably from all anode layers, on a first end face and combined into a bundle. The anode conductor tracks may be formed, in particular, directly from the particular uncoated substrate (i.e., the copper substrate foil). This applies similarly to the cathode conductor tracks (an aluminum substrate foil being correspondingly used). The aforementioned bundles of anode and cathode conductor tracks, which lead away from either the same (first) end face of the layer stack side by side (or on opposite edges of the end face) or from two opposite end faces (the first and second end faces), are electronically contacted with a corresponding anode or cathode current collector, both of which are each arranged on an inside of a (first) cover for a housing of the battery cell or a particular (first and second) cover for the housing. The contacting may take place, in particular, by a welding process in the manufacturing method. In particular, the cover herefor may initially by tilted or rotated 90° with respect to its provided position in the finished housing and brought into its actual position only for a pressing on.

In particular, in the case that the anode and cathode conductor tracks are guided out of the layer stack in each case on opposite end faces (the first or second end faces), only the anode conductor tracks or only the cathode conductor tracks are passed in the described manner through two insulation layers fastened at the relevant end face of the layer stack on the upper side or lower side thereof, while the other conductor tracks are insulated against the housing in another way on the other end face (i.e., in particular, without the described folds of second insulation layers). In an alternative embodiment, however, even in the aforementioned case that the anode and cathode conductor tracks are each guided out of the layer stack on opposite end faces (first or second end face), two insulation layers are each mounted on the upper side or lower side in the region of the two end faces, and the cathode and anode conductor tracks are correspondingly guided on their relevant sides to the associated current collector in the first or second cover by the folds of the insulation layers forming there in each case.

An anode terminal and/or a cathode terminal can be arranged on the outside of the first cover, which is/are electrically contacted with the associated anode current collector or cathode current collector through the first cover, so that the battery power of the battery cell may be tapped from the outside via the corresponding terminals.

An insulation layer can be fastened in each case to the upper side and the lower side of the layer stack, which are each constituted by a beginning or an end of the layering of the electrode layers, in such a way that a first end of the particular insulation layer is fastened to the upper side or lower side of the layer stack, and a free, second end of the insulation layer in question projects over the layer stack, preferable on this end face. These free ends of the insulation layers first follow the course of the bundle of anode or cathode conductor tracks. The insulation layers are guided around the combined, tapering bundles and each form a fold on their particular free (second) ends. This means, in particular, that the insulation layer fastened to the upper side of the layer stack (by its first end) is first oriented with its free (second) end in the direction of a mid-plane of the layer stack (n the stack direction), and the anode conductor tracks are guided between the end face of the layer stack and the aforementioned insulation layer. This insulation layer now forms a fold at its free end, preferably in the region of the mid-plane, in such a way that the free end is again oriented away from the mid-plane. The insulation layer fastened to the lower side of the layer stack forms a similar embodiment (however, with a symmetrical reversal of the references of upper and lower).

Two oppositely oriented folds of the two insulation layers, which point toward each other and are positioned, in particular, in the region of the mid-plane, are thus present. The bundles of the anode and cathode conductor tracks are guided through these two folds. In that the first cover of the finished battery cell is now pressed against the end face of the layer stack, the insulation layers may not draw back or slide back out of the aforementioned positioning as a result of their particular folds and a spring action arising at least indirectly against the pressure of the cover (e.g., against the first cover itself or against the aforementioned anode or cathode conductor tracks in the region of the first cover), but instead remained close to the aforementioned bundles, in particular with the folds. The aforementioned anode or cathode conductor tracks may be insulated hereby against the housing in the region of the end face of the layer stack or the first cover. The insulation layers are preferably manufactured for this purpose from an insulating material of a sufficient strength.

In the manufacturing method, an electrolyte can be injected into the battery cell prior to the final closure of the housing (for example, through an injection opening in the first cover provided for this purpose and to be closed afterwards) or in another way. In the manufacturing method, the contacting of the anode or cathode conductor tracks may take place, in particular, on the associated current collector of the first cover even after the application of the insulation layers to the layer stack as well as after the formation of their particular folds.

The housing can include the first cover with the inner anode current collector on the first end face of the layer stack, on which the anode conductor tracks guided between aforementioned folds of the two aforementioned insulation layers are contacted. The housing also includes a second cover on a second end face of the layer stack opposite the first end face, including the inner cathode current collector, on which the cathode conductor tracks guided between two folds of two more insulation layers are contacted, which are guided laterally out of the layer stack on the second end face. This means, in particular, that the battery cell has the anode terminal and the cathode terminal on two opposite end faces in each case. The contacting of the aforementioned terminals, and thus the associated current collectors, with the associated anode or cathode conductor tracks of the particular anode or cathode layers, takes place in each case by guiding them as described through two folds of two insulation layers pointing toward each other.

This means that, on the first end face of the layer stack, the anode conductor tracks are guided to the anode current collector through two insulation layers fastened there (and the folds formed thereby in this position as a result of the pressure due to the first cover). On the second end face of the layer stack, the cathode conductor tracks are guided to the cathode current collector through two insulation layers fastened there (and the folds formed thereby in this position as a result of the pressure due to the second cover).

When manufacturing a battery cell of this type, the anode conductor tracks guided out of the layer stack on the first end face may preferably be combined in a bundled manner and contacted with the associated anode current collector of the first cover, the first cover being pressed in the direction of the layer stack, so that a building pressure may be applied to the two folds, in particular at the associated two insulation layers, and the layer stack being fastened with the pressed-on cover, the cathode conductor tracks guided out of the layer stack on a second end face opposite the first end face being subsequently combined in a bundled manner (preferably after inserting the unit made up of the layer stack and anode-side cover into the housing) and contacted with the cathode current collector, which is arranged in a second cover for the housing, the second cover being pressed in the direction of the layer stack, so that a pressure is applied to the free ends of the associated insulation layers outside their particular fold, and the layer stack being enclosed within the housing with the aid of the fastened first cover and the pressed-on second cover. The fastening of the first cover to the layer stack may take place, for example, using a protective film, a protective envelope, or the like.

In particular, in terms of sequence, the cathode conductor tracks may be first contacted on the cathode current collector in the associated cover, and the aforementioned cover may be pressed against the layer stack (applying a pressure to the free ends of the associated insulation layers, between whose folds the cathode conductor tracks are guided) and fastened there, and the anode conductor tracks may then be contacted on the anode current collector in the associated other cover, and the aforementioned cover may be pressed against the layer stack (applying a pressure to the free ends of the associated insulation layers, between whose folds the anode conductor tracks are guided) and fastened there or enclosed within the housing.

The anode conductor tracks and the cathode conductor tracks can be guided laterally out of the layer stack on the first end face of the layer stack, offset with respect to the profile of the anode or cathode layers in parallel to each other, the first cover including the anode current collector and the cathode current collector, on which the anode conductor tracks and the cathode conductor tracks are each contacted, passing them through the folds of the aforementioned insulation layers. In this example, both terminals, the anode terminal and the cathode terminal, can be arranged on the same end face in the first cover for external tapping of the battery power. Correspondingly, the anode and cathode conductor tracks are guided out of the layer stack on the same end face, on which the insulation layers are each fastened on the upper and lower sides, through whose folds the anode and cathode conductor tracks are guided to their associated current collectors.

In the battery cell, a bundle of the anode conductor tracks and/or a bundle of the cathode conductor tracks preferably forms at least one loop between the layer stack and the first cover or the second cover, at least one of the two insulation layers, including their fold, being guided in the loop. This means, in particular, that, in a side view of the layer stack (with reference to the direction of the stack), these bundles are preferably wound in a single U-shape or also a double U-shape (in particular, with a particular complete crossing of the mid-plane of the layer stack described above). The aforementioned loop is formed, in particular, in that the anode or cathode conductor tracks have a certain excess length during and for the contacting with the associated current collectors in the cover, so that the aforementioned U-shaped winding(s) form(s) when pressing the first (or second) cover in the direction of the layer stack. At least one of the two insulation layers is then guided in the aforementioned U-shaped winding in such a way that the fold in question is preferably positioned in the region of the inner crest of the U-shaped convolution.

In particular, in the manufacturing method, at least one of the aforementioned insulation layers, preferably each of the two insulation layers on the same side, is guided for this purpose from above or from below in the direction of the bundles by an associated hold-down device, the hold-down device in question (or both hold-down devices) being removed during or after the pressing-on of the associated cover. The hold-down device thus guides the particular insulation layer to the bundles and presses the insulation layer around the bundle in the direction of the mid-plane of the layer stack, the fold of the insulation layer, in particular, also being able to form by the pressure of the hold-down device onto the insulation layer (e.g., from above) and by a counter-pressure applied by the bundle to anode or cathode conductor tracks (e.g., from below) outside the hold-down device. Due to the pressure applied by the associated cover or transferred by the bundles to the insulation layers and, in particular, to their folds, the particular fold remains in its position even after the hold-down device is removed, in particular in the region of the inner crest of the U-shaped winding of the described loop.

At least one additional insulation layer can be mounted on the bundle formed by the anode conductor tracks and/or on the bundle formed by the cathode conductor tracks in the region of the anode current collector or the cathode current collector.

The insulation layers are each suitably manufactured from a polyolefin, such a polypropylene (PP) or polyethylene (PE) and/or a polyimide. These insulating materials have particularly advantageous properties with respect to their formability of the folds.

The layer stack can be packed into a protective film, at least on the upper and lower sides, on which the insulation layers are fastened, in each case on their first end. The protective film prevents the layer stack from touching the housing with free active material in the finished battery cell and is thus also used for electrical insulation. The protective film may be manufactured, in particular, from PP. Alternatively or even additionally, the layer stack may terminate with a separator layer on the upper and lower sides in each case.

The insulation layers can each be glued on their first end for fastening to the layer stack, in particular with the aid of an adhesive, preferably self-adhesive, strip. The aforementioned adhesive, preferably self-adhesive, strip preferably covers only the region, in which the insulation layer in question is to be fastened on the layer stack and leaves recessed, in particular, the region which is to project over the layer stack.

The aforementioned insulation layers may expediently also be fastened to the top or bottom of the layer stack in a hot press step. A hot press step of this type is often used in the manufacturing of battery cells to join the individual electrode layers of the layer stack to the separator layers in a compact manner. Within the scope of this hot press step, the insulation layers are also fastened on the layer stack. In this case, in particular, the adhesive strips mentioned above may be dispensed with.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole figure schematically shows a method for manufacturing a battery cell including an electrode arrester insulation, based on a sequence of cross-sectional representations.

### DETAILED DESCRIPTION

A method for manufacturing a battery cell 1 is schematically illustrated in the figure, based on a sequence of cross-sectional representations of aforementioned battery cell 1 during manufacturing. Battery cell 1 is constituted by a Li-ion battery cell.

In a first method step S1, a plurality of anode layers An and a corresponding plurality of cathode layers K are provided as electrode layers. Anode layers An and cathode layers K, together with separator layers S, are alternately stacked into a layer stack 2 in such a way that a separator layer S always follows between an anode layer An and a cathode layer K.

Anode layers An may be manufactured, for example, in that a coating made from graphite or Si or SiOx is applied to a copper substrate foil. This coating forms the active material of anode layer An during the operation of finished battery cell 1. To manufacture cathode layers K, an aluminum substrate foil is preferably provided with a coating made from LFP or Li-NMC, this coating forming the active material of cathode layer K during the operation of finished battery cell 1. The coatings may be applied, in particular, to each of the two sides of the associated substrate foils for anode layers An or cathode layers K.

Separator layers S may each be constituted, in particular, by a ceramic-coated plastic film. Separator layers S are each placed between anode layers An and cathode layers K during the creation of layer stack 2. Layer stack 2, which has an essentially cuboid geometry, is preferably terminated in each case by a separator layer S on an upper side Fo and on a lower side Fu. Alternatively or additionally, a protective film may also be applied to layer stack 2, at least on aforementioned upper and lower sides Fo, Fu, which may be manufactured, for example, from PP. The termination of layer stack 2 by a separator layer S or by a protective film on upper or lower side Fo, Fu prevents layer stack 2 from touching the housing of finished battery cell 1 with an active material of one of electrode layers An, K. Layer stack 2 may also be subjected to a hot pressing for the purpose of joining separator layers S to adjacent anode or cathode layers An, K in a more compact manner. The hot pressing preferably takes place at a temperature of 60° C. to 90° C., particularly preferably 70° C. to 80° C.

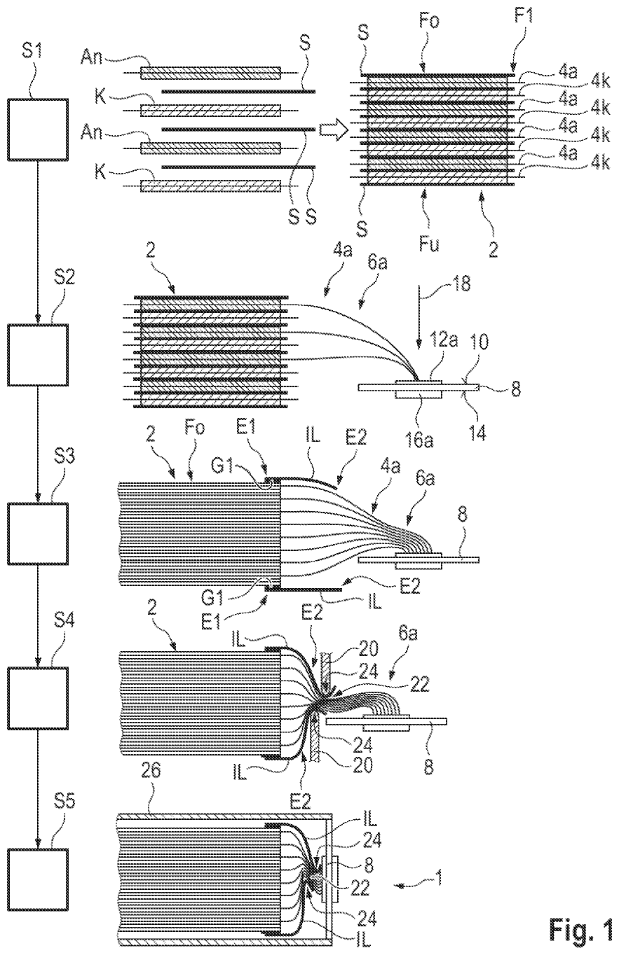

In the example illustrated in FIG. 1, individual anode conductor tracks 4a of anode layers An and cathode conductor tracks 4k of cathode layers K are guided out of layer stack 2 on an end face F1. Anode or cathode conductor tracks 4a, 4k are each offset laterally from each other with respect to the image plane, i.e., anode conductor tracks 4a are guided out laterally from the layer stack farther to the front (or farther to the back) than cathode conductor tracks 4k. Anode or cathode conductor tracks 4a, 4k may be formed directly from the particular uncoated substrate (i.e., the copper substrate foil of the anode layer or the aluminum substrate foil of the cathode layer). In a second method step S2, anode conductor tracks 4a of anode layer An are combined into a bundle 6a.

This bundle 6a of anode conductor tracks 4a is now electrically contacted on a first cover 8 for a housing of finished battery cell 1. For this purpose, an anode current collector 12a, which is electrically connected through first cover 8 to an anode terminal 16a arranged on an outside 14 of first cover 8, is arranged on an inside 10 (with respect to the later positioning of first cover 8 in finished battery cell 1). Finished battery cell 1 may be (electrically) connected later on from the outside on anode terminal 16a for a use in a battery system.

For the aforementioned contacting of anode conductor tracks 4a on anode current collector 12a, first cover 8 is first tilted 90° with respect to its later position in finished battery cell 1, so that anode current collector 12a is accessible from a direction 18 perpendicular to end face F1 (and in parallel to the stack in layer stack 2) for the aforementioned welding of anode conductor tracks 4a.

This similarly applies to cathode conductor tracks 4k of cathode layers K, which are arranged behind the image plane in Step S2 in FIG. 2 and are thus not illustrated separately. Cathode conductor tracks 4k are also combined into bundles and electrically contacted on a corresponding cathode current collectors on inside 10 of first cover 8, which is electrically connected to an associated cathode terminal on outside 14 of the first cover (for connecting finished battery cell 1 in a battery system). If necessary, the contacting described may also take place prior to the aforementioned hot pressing of layer stack 2.

In a third method step S3, insulation layers IL are now applied to layer stack 2 on upper or lower side Fo, Fu. insulation layers IL are preferably manufactured from a polyolefin, such as PP or PE, or from a polyimide. An insulation layer IL is fastened by its first end E1 on upper or lower side Fo, Fu in question of layer stack 2 (on separator layer S or the protective film), for which purpose insulation layer IK may be provided with a self-adhesive layer G1 on first end E1. Alternatively or additionally, particular insulation layer IL may also be fastened on upper or lower side Fo, Fu of the layer stack only by the hot press sub-step described above (which is carried out for this purpose only in method step S3), i.e., preferably on the plastic foil of separator layer S or the polymer protective film. Insulation layers IL each have free second ends E2, which project over layer stack 2 and are guided along anode or cathode conductor tracks 4a, 4k.

In a fourth method step S4, these free second ends E2 of insulation layers IL are now guided to bundle 6a of anode conductor tracks 4a or to the corresponding bundle of cathode conductor tracks 4k by hold-down devices 20, which are inserted next to layer stack 2 in direction 18 or against direction 18. Aforementioned bundle 6a forms a loop 22 (this similarly applies to bundles of cathode conductor tracks 4k, which are not visible in FIG. 1), which has a slight double winding, and into which insulation layers IL are pressed by particular hold-down device 20 from above or from below, so that second ends E2 of insulation layers IL each form a fold 24 in this loop 22. Hold-down devices 20 may be inserted slightly offset from each other, so that insulation layers IL of loop 22, which forms in bundle 6a, may be better adapted in each case from above or from below.

In a fifth method step S5, first cover 8 is now tilted 90° into its provided position, and the layer stack is enclosed in a housing 26. For this purpose, hold-down devices 20 are removed from loop 22 of bundle 6a of anode conductor tracks 4a (or of the corresponding bundle of cathode conductor tracks 4k), so that the first cover may be fastened on housing 26 (for example by welding). An electrolyte may be injected into housing 26 prior to the aforementioned fastening of first cover 8. This injection may also take place after the fastening of first cover 8 through a corresponding injection opening in first cover 8, which is to be closed afterwards. The manufacturing of batter cell 1 is completed hereby after the final closure.

Due to fold 24 of its free second end E2, an insulation layer IL remains in position in loop 22, even when hold-down device 20 is removed, due to the pressure applied indirectly via loop 22 by the bent anode or cathode conductor tracks, starting at the first cover. Only the tilted position of first cover 8 displaced in the direction of end face F1 is then significant. Loop 22 is made narrow enough thereby that a pulling back or sliding out of free second end E2 of insulation layer IL may be prevented via fold 24.

In an alternative variant, only anode conductor tracks 4a are guided out on first end face F1 of the layer stack, while cathode conductor tracks 4k are guided out of layer stack 2 on a second end face opposite first end face F1. The fastening of anode conductor tracks 4a by passing them between insulation layers IL on anode current collector 12a of first cover 8 takes place in the same manner as described in steps S2 through S4. First cover 8 is subsequently pressed against layer stack 2 and fastened thereto (e.g., with the aid of its protective film). Steps S2 through S4 are then repeated for fastening cathode conductor tracks 4k to the associated cathode current collector of a second cover, and cathode conductor tracks 4k are passed through forming folds of insulation layers fastened to layer stack 2 in the region of the second end face. The second cover is then pressed against layer stack 2 and the latter is enclosed in the housing.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery cell comprising:
a layer stack that includes a plurality of anode layers and a corresponding plurality of cathode layers, the anode layers and the cathode layers being alternately stacked one on top of the other;
a separator layer arranged between each anode layer and each cathode layer;
anode or cathode conductor tracks being guided laterally out of the layer stack at least on a first end face of the layer stack, at least from some of the anode layers and/or some of the cathode layers;
a housing, which surrounds the layer stack including the anode or cathode conductor tracks, and which includes a first cover with an inner anode current collector or an inner cathode current collector at least on the first end face of the layer stack, the anode conductor tracks or the cathode conductor tracks each being combined in a bundled manner and each being contacted on the anode current collector or on the cathode current collector; and
at least two insulation layers, which are each fastened to an upper side or a lower side of the layer stack by a first end; the at least two insulation layers each projecting over the layer stack with their free second ends, the second ends being oriented with respect to each other forming two folds that run toward each other so that the bundles of the anode conductor tracks or the cathode conductor tracks are each passed between the two folds, and the at least two insulation layers being held in position by a spring action of their particular folds against a pressure applied indirectly by the first cover.

2. The battery cell according to claim 1, wherein the housing comprises the first cover with the inner anode current collector on the first end face of the layer stack, on which the anode conductor tracks passed between the folds of the two insulation layers are contacted, and comprises a second cover with the inner cathode current collector on a second end face of the layer stack opposite the first end face on which the cathode conductor tracks passed between folds of two further insulation layers are contacted, which are guided laterally out of the layer stack on the second end face.

3. The battery cell according to claim 1, wherein the anode conductor tracks and the cathode conductor tracks are guided laterally out of the layer stack on the first end face of the layer stack, offset with respect to the profile of the anode or cathode layers in parallel to each other, the first cover including the anode current collector and the cathode current collector, on which the anode conductor tracks and the cathode conductor tracks are each contacted, passing them through the folds of the aforementioned insulation layers.

4. The battery cell according to claim 1, wherein a bundle of the anode conductor tracks and/or a bundle of the cathode conductor tracks forms at least one loop between the layer stack and the first cover or the second cover, and wherein at least one of the two insulation layers, including their fold, is guided in the loop.

5. The battery cell according to claim 4, wherein at least one additional insulation layer is mounted on the bundle formed by the anode conductor tracks and/or on the bundle formed by the cathode conductor tracks in the region of the anode current collector or the cathode current collector.

6. The battery cell according to claim 1, wherein the insulation layers are each manufactured from a polyolefin and/or a polyimide.

7. A method for manufacturing a battery cell, the method comprising:
alternately stacking a plurality of anode layers and a corresponding plurality of cathode layers into a layer stack;
arranging a separator layer between each anode layer and each cathode layer;
guiding anode conductor tracks or cathode conductor tracks laterally out of the layer stack at least from a portion of the anode layers and from a portion of the cathode layers and combined in a bundled manner and contacted with an anode current collector or a cathode current collector of a cover or, in each case, of a cover for a housing of the battery cell;
fastening at least one insulation layer to an upper side or a lower side of the layer stack such that the insulation layer projects over the layer stack;
guiding free ends of the insulation layers from above or from below to the bundles of the anode conductor tracks or cathode conductor tracks;
forming a fold;
pressing the cover in a direction of the layer stack so that a pressure is applied to the free ends of the insulation layers outside the particular fold; and
fastening the layer stack to the pressed-on cover and enclosing such in the housing during this process or thereafter.

8. The method according to claim 7, wherein the anode conductor tracks or cathode conductor tracks guided out of the layer stack on the first end face are first combined in a bundled manner and contacted with the associated anode current collector or a cathode current collector of the first cover for the housing of the battery cell, wherein the first cover is pressed in the direction of the layer stack, and the layer stack is fastened to the pressed-on cover; wherein the other conductor tracks of the anode conductor tracks or cathode conductor tracks, which are guided out of the layer stack on a second end face opposite the first end face, are combined in a bundled manner and contacted with the associated other current collector of the anode current collector or cathode current collector, which is arranged in a second cover for the housing; wherein the second cover is pressed in a direction of the layer stack so that a pressure is applied to the free ends of the associated insulation layers outside their particular fold, and wherein the layer stack is enclosed in the housing by the fastened first cover and the pressed-on second cover.

9. The method according to claim 7, wherein at least one of the insulation layers is guided from above or from below in a direction of the bundles by a hold-down device, the hold-down device being removed during or after the pressing-on of the associated cover.

10. The method according to claim 7, wherein the insulation layers are fastened to the top or bottom of the layer stack in a hot press step.

11. The method according to claim 7, wherein the insulation layers are each fastened to the upper side or to the lower side of the layer stack using an adhesive strip.
